(19) United States
(12) Patent Application Publication
(10) Pub. No.: US 2023/0196417 A1
(43) Pub. Date: Jun. 22, 2023

(54) SYSTEM, METHOD, AND GRAPHICAL USER INTERFACE FOR INTEGRATING DIGITAL TICKETS WITH PROMOTIONAL AND EDITORIAL REFERENCES AND CONTENT

(71) Applicant: Blake Hicks, Shiner, TX (US)

(72) Inventor: Blake Hicks, Shiner, TX (US)

(21) Appl. No.: 17/942,444

(22) Filed: Sep. 12, 2022

Related U.S. Application Data
(60) Provisional application No. 63/290,342, filed on Dec. 16, 2021.

(51) Int. Cl. G06Q 30/02

(52) U.S. Cl. CPC G06Q 30/0277

(57) ABSTRACT

A system for integrating digital tickets with working promotional and editorial content is disclosed, including at least one user computing device in operable connection with a network. An application server is in operable communication with the network to host an application program for displaying, via a display module, a landing page. The application program includes a user interface module for providing access to the landing page through the user interface module. A pass module provides an interactive ticket and displaying, via the display module the interactive ticket on the landing page.

### CROSS-REFERENCE TO RELATED APPLICATIONS

The present application claims priority to U.S. Provisional Patent Application No. 63/290,342 filed Dec. 16, 2021, entitled “SOFTWARE, METHOD, AND GRAPHICAL USER INTERFACE FOR INTEGRATING DIGITAL TICKETS WITH RICH PROMOTIONAL AND EDITORIAL CONTENT” which is hereby incorporated by reference in its entirety.

### TECHNICAL FIELD

The embodiments generally relate to computerized systems and methods for integrating digital tickets with various content forms.

### BACKGROUND

Valid access to event-specific attractions (e.g., games, live performances, concerts, festivals, conferences, productions, etc.) often takes the form of simple, single-purpose entities such as e-tickets, m-tickets, barcodes, QR codes, etc. Such event-specific attractions often generate a wealth of content that disseminates across the web on various sites and social platforms.

Access to the event and access to content remain largely unconsolidated. This makes it difficult and frustrating for the end user to enjoy together. Current mobile ticketing (or voucher-generating) systems are singularly focused on the mere issuance and distribution of the ticket (or pass) itself. Promotional and editorial content is handled separately by various content tools and platforms, forcing information-hungry attendees to go search for this information themselves.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments described herein relate to a system for integrating digital tickets with promotional and editorial references and content, including at least one user computing device in operable connection with a network. An application server is in operable communication with the network to host an application program for displaying, via a display module, a landing page. The application program includes a user interface module for providing access to the landing page through the user interface module. A pass module provides an interactive ticket and displaying, via the display module the interactive ticket on the landing page.

By integrating valid, functional digital tickets onto an interactive landing page, this system provides event creators with a single, dual-purpose URL for promotion and ticketing. It also provides ticket-holders with simultaneous access to the event and to the content associated with the link or other content they may be interested in.

A method is disclosed for integrating digital tickets with working promotional and editorial content. A landing page is created, and a pass URL is issued and transmitted to prospective pass holders. The pass URL may be transmitted electronically (e.g. though SMS, email, online chats, and/or notifications), or through electromagnetic induction via an NFC module. The pass is then activated by combining the unique identifier for the pass with a unique identifier for the user, or device associated with the pass purchase. The landing page is then displayed on the computing device. The landing page includes various information including the ticket, ticket information, user profile information, passholder information, and one or more links, references, and/or link previews.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a block diagram of a computing system and an application program, according to some embodiments;

FIG. 3 illustrates a screenshot of the graphical user interface including the initial state of the landing page which unifies the event tickets with the promotional and editorial content, according to some embodiments;

FIG. 4 illustrates a screenshot of the graphical user interface including the expanded state of the landing page which unifies the event tickets with the promotional and editorial content, according to some embodiments;

FIG. 5 illustrates a screenshot of the graphical user interface including landing page having content previews, according to some embodiments;

FIG. 6 illustrates a screenshot of the graphical user interface including landing page having working content previews, according to some embodiments;

FIG. 7 illustrates a block diagram showing a process of pass issuance, according to some embodiments; and

FIG. 8 illustrates a block diagram showing a process for URL delivery and activation, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments provided herein relate to a system, method, and graphical user interface for integrating digital tickets with working promotional and editorial content. By integrating valid, functional digital tickets onto an interactive landing page, this system provides event creators with a single, dual-purpose URL for use in ticketing and promotions. The system also provides pass-holders with simultaneous access to the event and to the content they desire.

Access to the event and access to content remain largely unconsolidated. This makes it difficult and frustrating for the end user to enjoy together. The invention claimed here solves this problem. By unifying an electronic ticket with an interactive reference landing page, this software creates visual and functional unity between event tickets and promotional content. This provides event creators with a highly effective promotional tool.

Digital tickets to an event and promotional and editorial content related to the event remain largely separate. This software fully integrates the two into one, interactive, functional visual presentation with a single URL. The valid, functional digital ticket is conjoined to a controlled set of associated links to content onto one singular presentation.

In some embodiments, a dual-purpose URL can be applied to or stored onto hardware, such as an RFID or NFC enabled (near-field communication) object. Such objects are fitted with a microchip which stores and delivers the pass URL to a mobile device. This provides ticket-holders with a tangible object that functions as a visible, physical, material pass for admission as well as a delivery mechanism for evoking the URL to display on an external smart phone, computer or other digital device.

In some embodiments, the user experience can be described from two points of view: The event-creator (EC), and the pass-holder (PH). The EC installs the application program onto the mobile device or computer or accesses it on the web through an online connection and the application program is activated. The EC is then presented with a pre-made, hosted landing page. They can customize it with their details and embed all associated commercial and editorial links. To embed associated links to content, the EC types or pastes any external URL into an affordance via the interface. The system automatically detects the properties of the external page in reference (i.e., page title, description, and image) and generates a working link preview with the respective media onto the landing page.

The EC is able to manipulate and alter the details of the preview by using mobile touch, mouse-controlled, or manually manipulable interface for controlling on-screen cursor activity.

When editing is complete, the saved work is published to the web and given a URL that contains a unique identifier (i.e., “pass” or “ticket”) which requires activation prior to use.

The software issues the pass URL (“ticket” or “pass”) either manually via the software's graphical user interface, or automatically through an Application Programming Interface (API). The URL is then delivered in one of two ways: 1) electronic dissemination (via a short message service (SMS), email, online chat, and/or notification) or 2) electromagnetic induction (via an NFC-enabled device containing an NFC microchip).

Next, the pass-holder (PH) enacts on the pass URL via a graphical user interface. The enacted URL opens the digital ticket created by the software and prompts the user to “activate” the pass.

To activate the pass, the system matches the unique identifier for the pass with a unique identifier for the user or device associated with the pass purchase. If the match is successful, the pass becomes activated, valid, accessible, unique, and non-transferable. When enacted, the pass presents a holistic assortment of relevant interactive content, conjoined with the valid, functional ticket information (i.e., ticket number, numeric codes, scannable codes, name, seat, gate, etc.).

The system and methods provide a platform which creates, unites, and delivers valid and functional ticket information a holistic assortment of interactive promotional and editorial content as a unified whole. It does so by augmenting a reference landing page with a unique identifier that can be issued, purchased and activated as a digital ticket.

The resulting “pass” or “ticket” is visually perceptible on any computer or mobile device. It is afforded with all the utilitarian detail of a valid ticket, and with the enhancements of a conjoined landing page filled with working promotional links.

To fill the landing page with working content, the system automatically derives working media from a pasted URL, and automatically generates a working graphical representation that can be altered. If the system is unable to detect elements for the working preview (i.e., page title, description, and image) then replacement content (which can be manually altered) is shown by default.

Once issued, to activate the digital pass the system matches the unique identifier for the pass with the unique identifier associated with the pass purchase. If the unique identifiers are matched successfully, the pass becomes activated and valid. Passes can only be activated once and are time-sensitive.

In some embodiments, the use of external near-field-communication (NFC) chips can be used to aid in the delivery and transmission of the pass URL. This provides a visible, physical, scannable representation of the pass (either placed or worn) that pass-holders use to enact the URL which can provide simultaneous access to both the event and the associated content.

In some embodiments and during use, the EC creates a reference landing page with both ticket details and working promotional content. Once saved, the software issues a URL with a unique identifier that is delivered electronically or through electromagnetic induction to the pass-holder. The pass-holder enacts on and activates the pass URL via the software's graphical user interface. The resulting presentation of the activated pass displays a single, functional, unified visual presentation from the ticket information and the associated promotional and editorial content.

The EG can activate their pass (or ticket) and view use their pass as access to both the physical gate at the event, as well as access to promotional content. When used in conjunction with NFC enabled devices, the PH enjoys a visible, physical, material pass for admission to an event and access to associated working content.

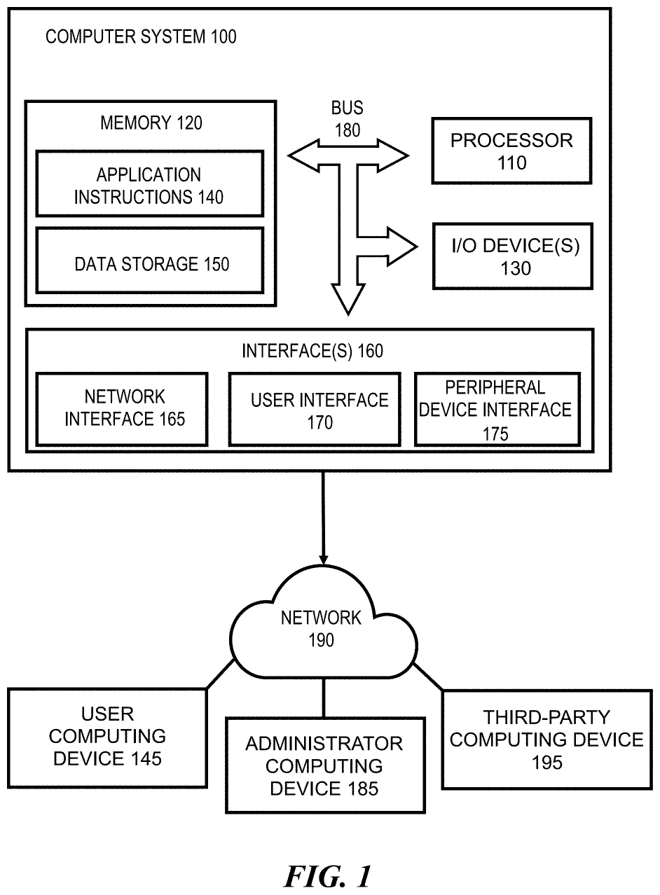

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized to establish credentials, create a user profile, and otherwise interact with the features of the system. The third-party computing device 195 may be utilized by third parties to receive communications from the user computing device and/or administrative computing device 185.

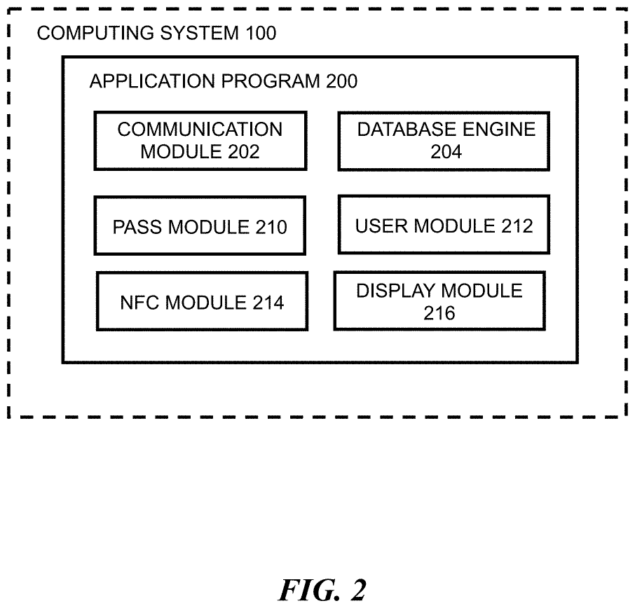

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a pass module 210, a user module 212, an NFC module 214, a display module 216.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. In some embodiments, the communication module 202 allows each user to transmit and receive information which may be used by the system.

In some embodiments, the communication module 202 is in operable communication with the social contact buttons and working link previews to allow users to communicate with other users, event-associated personnel, administrators, and/or third-parties.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations. The database engine 204 allows each user and module associated with the system to transmit and receive information stored in various databases.

In some embodiments, the database engine 204 derives working media from a pasted URL and automatically generates a working graphical representation (via the display module 216) that can be altered by the user.

In some embodiments, the pass module 210 is operable to associate a ticket or pass with a URL and thus embed associated links and content with a pass or ticket. The pass module 210 may generate working link previews in association with media onto the landing page.

In some embodiments, the pass module 210 creates, unites, and delivers valid and function pass (or ticket) information as well as an assortment of interactive promotional and editorial content onto the landing page of the graphical user interface. This allows the user to interact with their ticket/pass and other content via the landing page.

In some embodiments, the pass module 210 matches a unique identifier for the pass with the unique identifier associated with the pass purchase. If matched successfully, the pass becomes activated and valid.

In some embodiments, the user module 212 facilitates the creation of a user account for the application system. The user module 212 may allow the user to input account information, establish user permissions and the like. The user module 212 may be in communication with the landing page to appropriately display the page profile image, social contact buttons, pass holder name, and the like.

In some embodiments, the NFC module 214 permits the user to scan an NFC chip to enact the URL. Once the pass is activated, the NFC module 214 writes the pass URL to the NFC chip on the computing device.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

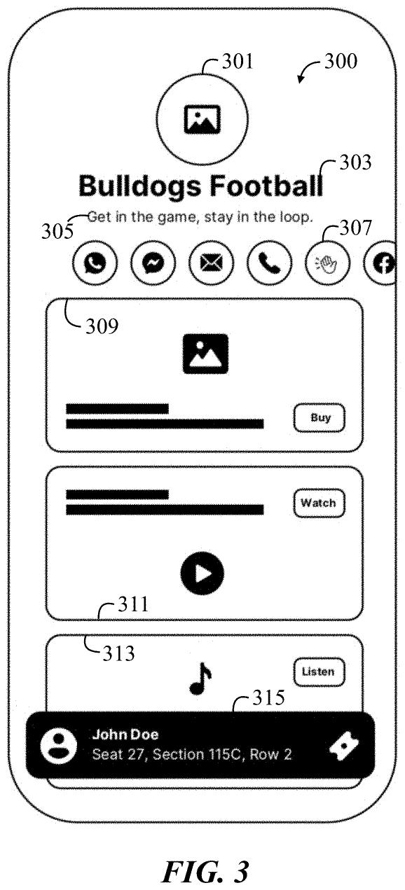

In some embodiments, the display module 216 is operable to display the various aspects illustrated in FIGS. 3-8 described below, including the landing page, ticket, working media links, etc.

FIG. 3 illustrates a screenshot of the graphical user interface including the initial state of the landing page 300 which unifies the event tickets with the promotional and editorial content. As stated, digital tickets to an event and any related content remain largely separate. The embodiments fully integrates the two into one, interactive, functional, visual presentation with a single URL. The valid ticket is conjoined onto one page with a controlled set of associated links to content. The landing page includes a profile image 301, landing page title 303, and landing page description 305 each related to an event. Social contact buttons 307 allow the user to select a means of communication with other users, administrators, event-associated personnel, or third-parties. Multi-media content is provided in a feed 309 which may display content associated with the event. Similarly, a video feed 311 and audio feed 313 are provided to allow access to media content. An interactive ticket 315 is illustrated including ticket information including the passholder profile, name, and pass utility details.

In some embodiments, the system augments a reference landing page with a unique identifier that can be issued, purchased and activated as a digital ticket. The resulting “pass” or “ticket” is visually perceptible on any computer or mobile device. It is afforded with all the utilitarian detail of a valid ticket, and with the enhancements of a conjoined landing page filled with working promotional links.

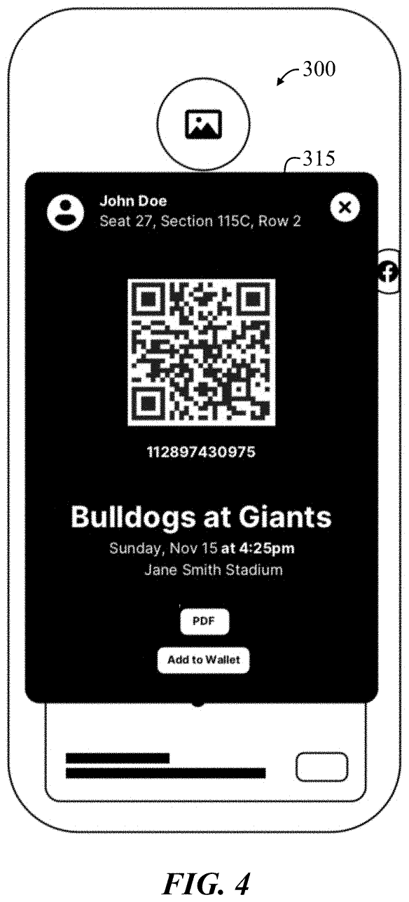

FIG. 4 illustrates a screenshot of the graphical user interface including the expanded state of the landing page 300 which unifies the event tickets with the promotional and editorial content. The interactive ticket 315 is shown including ticket details. The ticket details may include a code, ticket number, event title, event date and time, event location, as well as means for downloading the ticket and associating the ticket with a digital wallet.

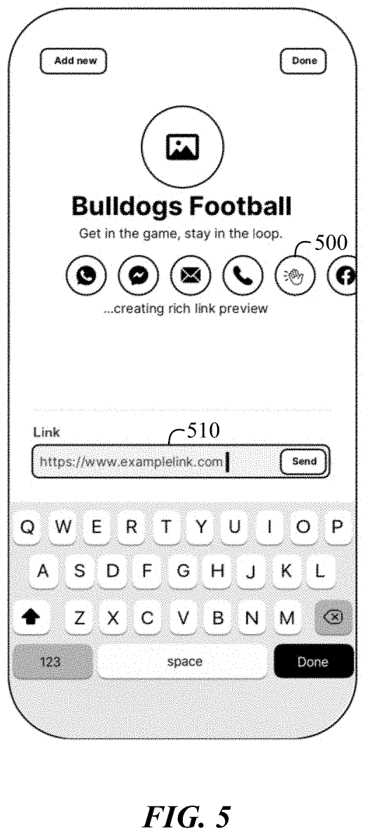

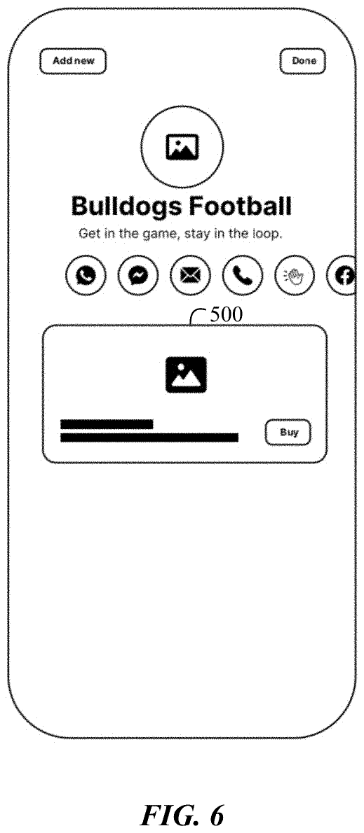

FIG. 5 illustrates a screenshot of the graphical user interface including landing page having working content previews 500. The working content previews 500 include selectable tabs including means for communicating with other users, third-parties, event-associated personnel, etc. The EC types or pastes any external URL 510 into an affordance via the interface. The system automatically detects the properties of the external page in reference (i.e., page title, description, and image) and generates a working link preview with the respective media onto the landing page. FIG. 6 illustrates a screenshot of the graphical user interface including landing page having working content previews 500. The user is provided with a preview window showing the media, an option to make a purchase, as well as other associated information.

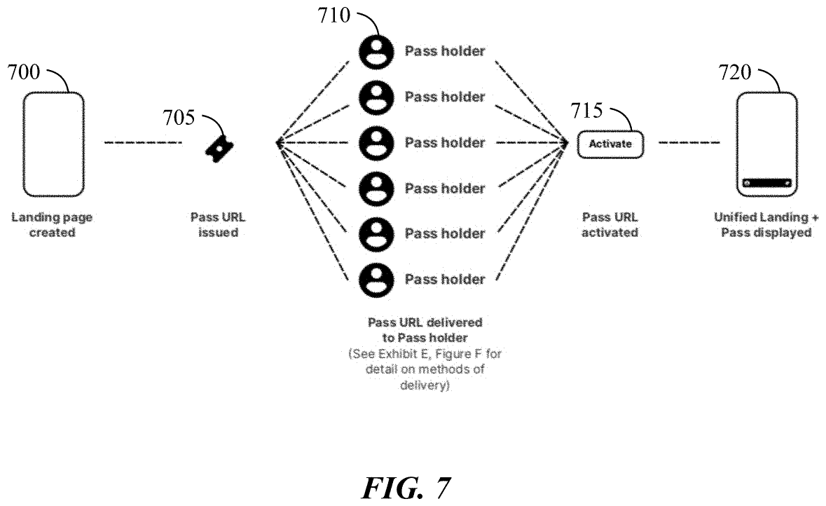

FIG. 7 illustrates a block diagram showing a process of pass issuance. In block 700, the system augments a reference landing page with a unique identifier that can be issued (as a pass URL (see block 705), purchased and activated as a digital ticket. The resulting “pass” or “ticket” is visually perceptible on any computer or mobile device. It is afforded with all the utilitarian detail of a valid ticket, and with the enhancements of a conjoined landing page filled with working promotional links. In block 710, the EC issues the pass URL “ticket” or “pass”) manually via the systems graphical user interface, or the URL is issued automatically through an Application Programming Interface (API). The URL is then delivered in one of two ways: 1: electronic dissemination (via a short message service (SMS), email, online chat, and/or notification), or 2: electromagnetic induction (via an NFC-enabled device containing an NFC microchip).

In some embodiments, the pass URL (block 705) may be completed first before the landing page is created (block 705).

Once issued, to activate the digital pass the software matches the unique identifier for the pass with the unique identifier associated with the pass purchase. If the unique identifiers are matched successfully, the pass becomes activated and valid. Passes can only be activated once and are time-sensitive.

The pass-holder (PH) enacts on the pass URL via a graphical user interface. The enacted URL opens the digital ticket created by the system and prompts the user to “activate” the pass. To activate the pass, the system matches the unique identifier for the pass with a unique identifier for the user or device associated with the pass purchase. If the match is successful, the pass becomes activated (as shown in block 715), valid, accessible, unique, and non-transferable. When enacted, the unified landing page and pass is displayed as shown in block 720. The pass presents a holistic assortment of relevant interactive content, conjoined with the valid, functional ticket information (i.e., ticket number, numeric codes, scannable codes, name, seat, gate, etc.).

In some embodiments, once the landing page is displayed, they user may customize it with their details, and embed all associated commercial and editorial links. To embed associated links to content, the EC types or pastes any external URL into an affordance via the interface. The software automatically detects the properties of the external page in reference (i.e., page title, description, and image) and generates a working link preview with the respective media onto the landing page.

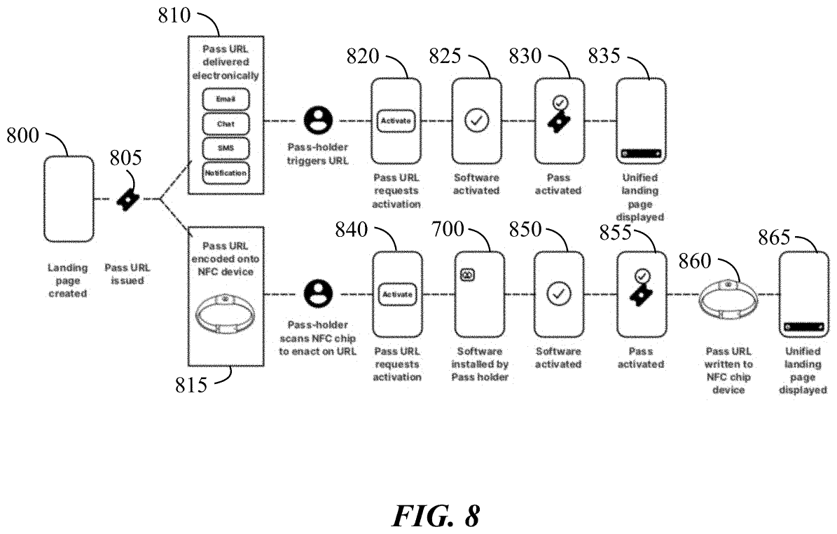

FIG. 8 illustrates a block diagram showing a process for URL delivery and activation. The landing page is created in block 800. In block 805, the system issues the pass URL (“ticket” or “pass”) either manually via the system's graphical user interface, or automatically through an Application Programming Interface (API). The URL is then delivered in one of two ways. As shown in block 810 the URL is disseminated electronically (via a short message service (SMS), email, online chat, and/or notification) or (as shown in block 815) electromagnetic induction (via an NFC-enabled device containing an NFC microchip).

In some embodiments, the pass URL (block 805) may be created first before the landing page is created (block 805).

In an embodiment wherein the URL is delivered electronically via SMS, email, online chat, and/or notifications, the pass URL requests activation in block 820. In block 825, the software is activated, and the pass is activated in block 830. In block 835, the unified landing page is displayed on the user's computing device.

In an embodiments wherein the URL is delivered via electromagnetic induction, the pass URL requests activation as shown in block 840. In block 845, the software is installed by the pass holder and in block 850, the software is activated. In block 855 the pass is activated, and the pass URL is written to the NFC chip device (see block 860). In block 865, the landing page is displayed.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for integrating digital tickets with working promotional and editorial content, comprising:
at least one user computing device in operable connection with a network;
an application server in operable communication with the network, the application server configured to host an application program for displaying, via a display module, a landing page, the application program having a user interface module for providing access to the landing page through the user interface module; and
a pass module for providing an interactive ticket and displaying, via the display module the interactive ticket on the landing page.

2. The system of claim 1, further comprising an NFC module to encode a pass URL onto the wireless transmission device.

3. The system of claim 2, wherein the NFC module permits the user to scan an NFC chip to enact the pass URL.

4. The system of claim 1, wherein the landing page includes a landing page title, a profile image, a landing page description, and a plurality of pass holder information.

5. The system of claim 4, wherein the landing page includes a promotional link.

6. The system of claim 5, wherein the landing page may include an editorial link.

7. The system of claim 6, wherein the landing page may include an RSS feed link.

8. The system of claim 1, wherein the interactive ticket includes a scan code.

9. The system of claim 8, wherein the interactive ticket includes a ticket ID number, an event title, an event date and time, and an event location.

10. The system of claim 1, wherein the landing page includes one or more social contact buttons.

11. The system of claim 1, wherein the landing page includes one or more working links.

12. The system of claim 11, wherein rich link previews are also derived from a URL and associated with external, hosted digital content.

13. The system of claim 12, wherein content is also derived from an RSS Feed URL.

14. A system for integrating digital tickets with working promotional and editorial content, comprising:
at least one user computing device in operable connection with a network;
an application server in operable communication with the network, the application server configured to host an application program for displaying, via a display module, a landing page, the application program having a user interface module for providing access to the landing page through the user interface module; and
a pass module for providing an interactive ticket and displaying, via the display module the interactive ticket on the landing page; and
one or more working links displayed on the landing page, wherein working links and previews are also derived from a URL and can be associated with an RSS feed, a video feed and an audio feed;
an NFC module to transmit a pass URL to a passholder via electromagnetic induction.

15. The system of claim 14, further comprising an NFC module to encode a pass URL onto the electronic transmission device.

16. The system of claim 15, wherein the landing page includes a landing page title, a profile image, a landing page description, and a plurality of pass holder information.

17. The system of claim 16, wherein the landing page includes a promotional link.

18. The system of claim 17, wherein the landing page may include an editorial link.

19. The system of claim 18, wherein the landing page includes one or more social contact buttons.

20. A method for integrating digital tickets with working promotional and editorial content, the method comprising the steps of (in no certain order):
creating a landing page;
issuing a pass URL;
transmitting the pass URL to one or more pass holders;
activating the pass URL; and
displaying the landing page on a computing device, the landing page including an interactive ticket and at least one working link preview.

21. The method of claim 20, wherein the pass URL is transmitted electronically via an SMS, an email, a chat, or a notification.

22. The method of claim 21, wherein the pass URL is transmitted via electromagnetic induction via an NFC module.
